(19) United States
(12) Patent Application Publication
(10) Pub. No.: US 2026/0111019 A1
(43) Pub. Date: Apr. 23, 2026

(54) METHOD FOR MONITORING A PRODUCTION MACHINE AND MONITORING DEVICE

(71) Applicant: Siemens Aktiengesellschaft, München (DE)

(72) Inventors: Harald Völkl, Garching (DE); Juan Manuel Lorenzi, Garching (DE)

(21) Appl. No.: 19/362,862

(22) Filed: Oct. 20, 2025

(30) Foreign Application Priority Data
Oct. 22, 2024 (EP) 24208072.9

(51) Int. Cl. G05B 23/02

(52) U.S. Cl. CPC G05B 23/0254; G05B 23/0264

(57) ABSTRACT

A current operating signal continuously acquired to monitor a production machine. A time window is acquired for each of a large number of workpieces, and a curve of the operating signal that is limited to the respective time window is acquired for each time window. In addition, a respective quality parameter of the respective workpiece being machined is acquired. Furthermore, in the event of a deviation between a respective operating signal curve and a target curve, it is checked whether a fault cause is assigned to the respective operating signal curve in a monitoring database. If not, the respective quality parameter is output together with a request to enter a fault cause, the respective fault cause is read in, and the respective operating signal curve, the respective quality parameter and the respectively read-in fault cause are stored in the monitoring database in a manner assigned to one another.

### CROSS-REFERENCE TO RELATED APPLICATIONS

This application claims priority to EP Application No. 24208072.9, having a filing date of Oct. 22, 2024, the entire contents of which are hereby incorporated by reference.

### FIELD OF TECHNOLOGY

The following relates to method for monitoring a production machine and monitoring device.

### BACKGROUND

Complex production processes usually require reliable quality monitoring of the manufactured or machined products or workpieces. Ideally, the causes of quality defects should be identified as early as possible here in order to avoid future quality problems in a targeted manner.

In modern production machines, current production data is generally evaluated continuously and control functions are provided, for example, to stop a production process when a predefined tolerance is exceeded.

In many cases, however, the ability to automatically identify or indicate a cause for the occurrence of a quality problem is lacking. In addition, many production machines cannot automatically learn to prevent a problem in the future after this or a similar problem occurs. In such cases, operators are often required to manually identify the cause of a problem using checklists and other methods and take appropriate countermeasures. However, such a cause determination process is usually relatively time-consuming.

### SUMMARY

An aspect relates to a method and a monitoring device for monitoring a production machine requiring less outlay.

This aspect is achieved by way of a method, by way of a monitoring device, by way of a computer program and by way of a computer-readable storage medium.

To monitor a production machine during operation, a current operating signal of the production machine is continuously acquired. In addition, a time window in which the respective workpiece is machined by way of the production machine is acquired for each of a large number of workpieces, and a curve of the operating signal that is limited to the respective time window is acquired for each time window. In addition, a respective quality parameter of the respective workpiece being machined is acquired. Furthermore, as a result of detection of a deviation between a respective operating signal curve and a target curve, it is checked whether a fault cause is assigned to the respective operating signal curve in a monitoring database. If this is not the case,
a piece of information about the respective quality parameter is output by way of a user interface together with a request to enter a respective fault cause,
the respective fault cause is read in by way of the user interface, and
the respective operating signal curve, the respective quality parameter and the respectively read-in fault cause are stored in the monitoring database in a manner assigned to one another. Otherwise, the assigned fault cause is output and/or the production machine is actuated depending on the assigned fault cause.

In order to carry out the method according to embodiments of the invention, provision is made for a monitoring device according to embodiments of the invention, a computer program product (non-transitory computer readable storage medium having instructions, which when executed by a processor, perform actions) and a computer-readable, for example non-volatile, storage medium.

The method according to embodiments of the invention as well as the monitoring device according to embodiments of the invention can be carried out or implemented in particular by means of one or more processors. The method according to embodiments of the invention may furthermore be executed at least partially in a so-called edge device and/or in a cloud.

An advantage of embodiments of the invention can be considered in particular the fact that a monitoring device can be augmented with manually tested fault causes during operation and can thus to a certain extent learn to identify fault causes automatically. This means that many production problems or production faults can automatically be identified at an early stage and, if necessary, prevented or mitigated. In embodiments, suitable countermeasures specific to the fault cause can be prompted or automatically initiated.

According to an embodiment of the invention, the respective operating signal curve, the respective quality parameter and the respectively read-in fault cause can be stored in a knowledge graph in a manner assigned to one another. In embodiments, the respective operating signal curve, the respective quality parameter as well as the respectively read-in fault cause can be specified semantically in the knowledge graph. The respective operating signal curve, the respective quality parameter as well as the respectively read-in fault cause are for example each stored as a node and their assignment is stored as an edge in the knowledge graph. A plurality of efficient standard methods are available for creating, managing and using knowledge graphs.

According to an embodiment of the invention, a pattern recognition routine can extract a characteristic signal pattern from each of the acquired operating signal curves. Accordingly, in order to detect the deviation from the target curve, the respectively extracted signal pattern can be compared with a target signal pattern extracted from the target curve by the pattern recognition routine. Furthermore, the respective operating signal curve can be stored in the monitoring database in the form of the respectively extracted signal pattern. In embodiments, a signal pattern that is characteristic of the machining of a particular workpiece can be assigned to this workpiece or its type in the monitoring database. The signal pattern can to a certain extent be used as a fingerprint to identify the relevant workpiece machining and/or to easily detect deviations from the target curve.

Furthermore, the acquired operating signal curves can be are subjected to a cluster analysis by means of a clustering routine, wherein the acquired operating signal curves are divided into clusters of similar operating signal curves. Accordingly, in order to detect the deviation from the target curve, it can be checked whether the respective operating signal curve is in the same cluster as the target curve. The target curve or even multiple target curves can for example be included in the cluster analysis and thus assigned to a respectively resulting cluster. The respective operating signal curve can also be stored in the monitoring database in the form of an identifier of the corresponding cluster. In this way, a monitoring device can to a certain extent learn to distinguish between operating signal curves in an automated manner. A plurality of efficient analysis methods, such as so-called k-means methods or DBSCAN (density-based spatial clustering of applications with noise) methods, are available for carrying out such a cluster analysis.

According to an embodiment of the invention, in the event that the respective quality parameter fails to meet a predefined quality criterion, it can be checked whether a fault cause is assigned to the respective quality parameter in the monitoring database. If this is not the case, the information about the respective quality parameter can be output by way of the user interface together with the request to enter the respective fault cause. An entered fault cause can then be stored in the monitoring database in association with the respective quality parameter for the respective operating signal curve. In this way, the monitoring database can be augmented with manually checked fault causes during operation and thus to a certain extent can learn to identify fault causes automatically based on an acquired operating signal curve and/or quality parameters.

Furthermore, the target curve can be derived from previous operating signal curves in which the quality parameter in question has met a predefined quality criterion. To derive the target curve, one or more of the previous operating signal curves can be selected, these having an optimum quality parameter with regard to the quality criterion. As an alternative or in addition, multiple previous target profiles can be averaged for this purpose. In this way, the target curve can be determined or adjusted during operation.

The quality parameter can be determined in particular by means of an optical sensor, by means of a camera and/or by means of a sensor for measuring a geometric property, an electrical property, a mechanical property, an optical property or a material property or for measuring a surface roughness. In addition, the quality parameter can be determined by way of quality control.

According to an embodiment of the invention, a piece of information about the respective operating signal curve can also be output by way of the user interface together with the information about the respective quality parameter. The former information makes it easier for an operator or a user in many cases to find a correct fault cause.

It can also be checked whether a quality parameter is assigned to the respective operating signal curve in the monitoring database. If this is the case, the assigned quality parameter can be output and/or the production machine can be actuated depending on the assigned quality parameter. The assigned quality parameter can often be seen as a measure of the expected machining quality. If the assigned quality parameter indicates a lack of machining quality, the production machine can for example be actuated in such a way that countermeasures specific to the fault cause are prompted and/or initiated. The assigned fault cause can be used to identify suitable countermeasures. As an alternative or in addition, the production machine or at least machining process of the current workpiece can be stopped. In addition, an operator or a user can be warned accordingly.

According to a development of embodiments of the invention, a large language model, such as GPT-4, GPT-3, BLOOM, LLaMA, T5-11B, PaLM-E, Gemini Pro or Mixtral 8x7b, which is pretrained to use input text to generate response texts related thereto, can be provided. The input texts and response texts can be formulated in particular in natural language. Large language models of this type are often abbreviated to LLM and have been generally available or usable for some time. In embodiments, a so-called generative pretrained transformer, abbreviated to GPT, can be used as a large language model. The stored operating signal curves, quality parameters, fault causes and their mutual assignments can then be supplied to the large language model in text form, for example within the scope of finetuning, prompt engineering or another form of post-training. The user interface can also be used to read in a user request and feed it in the form of an input text into the large language model which generates a response text therefrom. The response text can then be output by way of the user interface. This enables an operator to communicate in natural language via the user interface. In addition, in many cases, additional useful information can be obtained from the response text, insofar as large language models have good inference and abstraction capabilities, as experience has shown.

According to an embodiment of the invention, in the event that multiple fault causes are assigned to the respective operating signal curve in the monitoring database, these fault causes are output by way of the user interface in order to select an appropriate fault cause. A selection option of this type often makes it easier to enter a fault cause.

Operating signal curves and/or quality parameters of multiple production machines can also be acquired and stored in the monitoring database for all production machines, for example in a knowledge graph. Accordingly, an operating signal curve and/or quality parameter acquired in a first production machine can be assigned a fault cause in a second production machine, different from the first production machine, in the monitoring database, for example in the knowledge graph. In this way, effects of fault causes caused by previous machining steps can be assigned, correlated, logged, evaluated and/or modeled across multiple production machines.

Similarly, a quality parameter acquired in the first production machine can be assigned to an operating signal curve and/or quality parameter acquired in the second production machine. This enables effects of a quality of a previous machining step on a quality of a later machining step to be assigned, correlated, logged, evaluated and/or modeled across multiple production machines.

### BRIEF DESCRIPTION

Some of the embodiments will be described in detail, with reference to the following figures, wherein like designations denote like members, wherein:

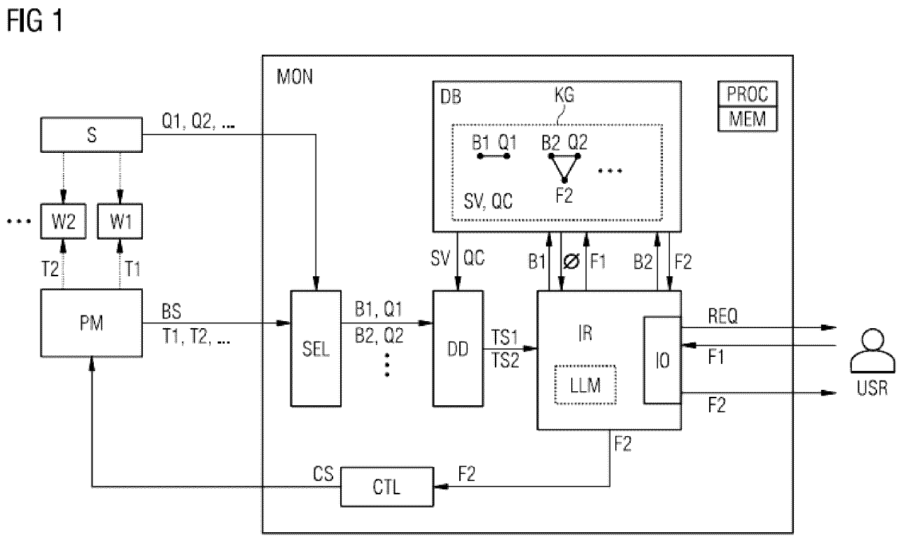

FIG. 1 shows monitoring of a production machine by way of a monitoring device according to embodiments of the invention; and

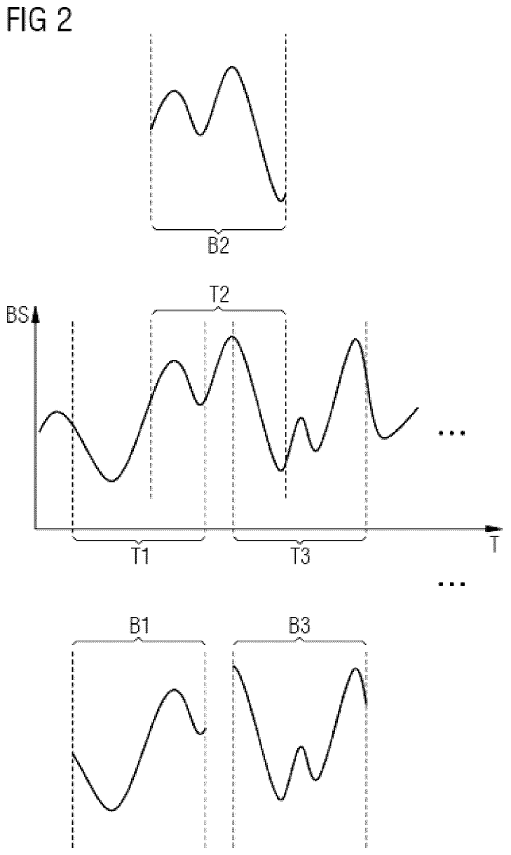

FIG. 2 shows curves of an operating signal over multiple workpiece-specific time windows.

Where the same or corresponding reference signs are used in the figures, these reference signs denote the same or corresponding entities, which may in particular be implemented or embodied as described in connection with the figure in question.

### DETAILED DESCRIPTION

FIG. 1 shows monitoring of a production machine PM by way of a monitoring device MON according to embodiments of the invention. The production machine PM may be in particular a machine tool, a robot, a conveyor belt system or a manufacturing plant or may comprise such a machine.

The monitoring device MON has one or more processors PROC for carrying out the method steps of embodiments of the invention and one or more memories MEM to store data to be processed.

The monitoring device MON is illustrated outside the production machine M and is coupled to the latter in FIG. 1. As an alternative, the monitoring device MON can also be integrated fully or partly into the production machine PM or into a control device for controlling the production machine. The monitoring device MON is for example implemented fully or partly in a so-called edge device.

Workpieces W1, W2, . . . are continuously machined by the production machine PM. The plurality of workpieces W1, W2, . . . may include products, subproducts, intermediate products or other workpieces to be machined.

A respective workpiece W1 or W2, . . . is machined within a respective time window T1 or T2, . . . with it also being possible for the time windows T1, T2, . . . to overlap. For each workpiece W1 or W2, . . . the production machine PM acquires the corresponding time window T1 or T2, . . . wherein a start of the respective time window is set to a beginning of the machining of the respective workpiece W1 or W2, . . . and an end of the time window is set to an end of this machining. Accordingly, the time windows T1, T2, . . . can each be represented by a pair of numbers.

Furthermore, one or more current operating signals BS of the production machine PM are acquired continuously by the monitoring machine MON. The operating signals BS can be output and/or acquired detected or measured by sensor during operation of the production machine PM. The operating signals BS are in each case acquired as time series over time.

The operating signals BS may include in particular current control signals, manipulated values, control parameters, control signals, measured values, sensor signals, ambient signals, monitoring signals, diagnostic signals and/or fault signals of the production machine PM. The operating signals BS can be used to quantify, for example, a power, a speed, a torque, a movement speed, an exerted or acting force, a temperature, a pressure, available resources, a resource consumption, a pollutant emission, wear, load or vibration of the production machine PM and/or a position, orientation or a machining state of workpieces.

The operating signals BS, together with the time windows T1, T2, . . . are transmitted continuously from the production machine PM to the monitoring device MON and fed into a selection device SEL of the monitoring device MON. The selection device is used, among other things, to select time window-specific segments from a respective operating signal BS. For reasons of clarity, only the processing of a single operating signal BS is explicitly illustrated below.

Furthermore, a sensor system S is used to continuously measure or otherwise acquire a respective machining quality of the respective workpiece W1 or W2, . . . after it has been machined. For this purpose, the sensor system S may include, for example, a camera, an optical sensor and/or a sensor for measuring geometric properties, electrical properties, mechanical properties, optical properties, material properties or for measuring a surface roughness of the workpiece W1 or W2, . . . in question. The sensor system S can be at least partly integrated into the production machine PM or into the monitoring device MON or can be implemented externally for this purpose.

The machining quality of a respective workpiece W1 or W2, . . . is quantified by a respective workpiece-specific quality parameter Q1 or Q2, . . . In embodiments, a deviation from a predefined geometry, strength, stability, transparency, conductivity and/or surface roughness of the workpiece W1 or W2, . . . in question can be quantified as a result. In addition, a respective quality parameter Q1 or Q2, . . . may include information about whether or not a predefined quality criterion has been met.

The acquired quality parameters Q1, Q2, . . . are transmitted from the sensor system S to the monitoring device MON and fed into the selection device SEL.

The selection device SEL is used to assign a respective quality parameter Q1 or Q2, . . . to the respective corresponding time window T1 or T2, . . . as well as to a curve B1 or B2, . . . that is limited to the respective time window T1 or T2, . . . of the operating signal BS. This means that the quality parameter QN, which affects an N-th workpiece WN, N=1, 2, . . . , is assigned to the time window TN in which this workpiece WN was machined and to the operating signal curve BN during this machining.

FIG. 2 illustrates different curves B1, B2, B3, . . . of the operating signal BS over different workpiece-specific time windows T1, T2, T3, . . . In the graph shown, the operating signal BS is plotted on the ordinate against the time T on the abscissa. Furthermore, the limits of the time windows T1, T2 and T3, i.e., the start and end of each machining process of a corresponding workpiece, are indicated by dotted vertical lines.

A respective time window T1 or T2, T3, . . . delimits a respective time segment of the operating signal BS. The curve of the operating signal BS over a particular segment is acquired as a workpiece-specific operating signal curve B1 or B2, B3, . . . This means that the segment of the operating signal BS over the time window T1 forms the operating signal curve B1, the segment over the time window T2 forms the operating signal curve B2, etc.

As is also illustrated in FIG. 1, the various operating signal curves B1, B2, . . . are specifically selected from the operating signal BS by the selection device SEL according to the transmitted time windows T1, T2, . . . and in each case transmitted from the selection device SEL to a deviation detector DD of the monitoring device MON in a manner assigned to the corresponding quality parameters Q1 or Q2,.

The operating signal curves B1, B2, . . . can each be displayed, stored, compared and processed in different ways.

In a particularly simple way, the operating signal curves B1, B2, . . . can be displayed, stored, compared and processed as a time series, i.e., as a vector of successive values of the operating signal BS in the time window T1 or T2, . . . To compare two such time series, for example, it is possible to determine the Euclidean distance between the representing vectors of these time series. The Euclidean distance in this case quantifies a deviation between the respective time series. In the case of vectors of different dimensions, the lower-dimension vector can be extended by default values, or a sample rate conversion can be performed to align the dimensions of the vectors.

As an alternative or in addition, a characteristic signal pattern can be extracted from a respective operating signal curve B1 or B2, . . . by means of a pattern recognition routine. The operating signal curves B1, B2, . . . can each be displayed, stored, compared and processed in the form of their characteristic signal pattern. The characteristic signal patterns can be specified and represented, for example, by characteristic amplitudes, amplitude curves, fluctuations, correlations or frequencies. To compare two such signal patterns and to determine a deviation between these signal patterns, analogous to the above case, it is possible to determine, for example, the Euclidean distance between representing vectors of these signal patterns.

The pattern recognition is for example carried out in the selection module SEL. In this case, a respective operating signal curve B1 or B2, . . . in the form of its characteristic signal pattern in association with the corresponding quality parameters Q1 or Q2, . . . can be transmitted from the selection module SEL to the deviation detector DD and processed there in this form.

As an alternative or in addition, the operating signal curves B1, B2, . . . can be subjected to a cluster analysis by means of a clustering routine, wherein the acquired operating signal curves are divided into clusters of similar operating signal curves. The operating signal curves B1, B2, . . . can then each be displayed, stored, compared and processed in the form of an unambiguous cluster identifier. In this case, in order to compare two operating signal curves, it is possible to check whether or not the operating signal curves to be compared are in the same cluster, i.e., whether or not their cluster identifiers match. If both operating signal curves are not in the same cluster, a deviation is detected; otherwise it is not.

The cluster analysis is for example carried out in the selection module SEL, for example by means of a so-called k-means method or a so-called DBSCAN method. This means that a respective operating signal curve B1 or B2, . . . in the form of its cluster identifier in association with the corresponding quality parameters Q1 or Q2, . . . can be transmitted from the selection module SEL to the deviation detector DD and processed there in this form.

The deviation detector DD continuously compares the transmitted operating signal curves B1, B2, . . . in each case with one or more target curves SV in order to detect deviations from a target behavior of the production machine PM. The at least one target curve SV is read in from a monitoring database DB of the monitoring device MON by the deviation detector DD. Depending on how the operating signal curves B1, B2, . . . are represented by time series, signal patterns or cluster recognitions, the at least one target curve SV can be represented in a corresponding manner by a time series, by a characteristic signal pattern or by a cluster recognition and can be compared as described above in this form with the operating signal curve B1 or B2, . . . in question. For reasons of clarity, only a comparison with a single target curve SV is explicitly shown below.

The deviation detector DD detects precisely one deviation between a respective operating signal curve B1 or B2, . . . and the target curve SV compared with it if the Euclidean distance between the representing vectors of the compared curves exceeds a predetermined threshold value or if the compared curves are in different clusters.

In addition, the deviation detector DD also continuously checks whether the quality parameters Q1, Q2, . . . transmitted fail to meet a predefined quality criterion QC, for example a required geometry, strength, stability, transparency, conductivity and/or surface smoothness of the respective workpiece W1 or W2, . . . The quality criterion QC is also read in from the monitoring database DB by the deviation detector DD.

If a deviation from the target curve SV is detected for a respective operating signal curve B1 or B2, . . . or if a respective quality parameter Q1 or Q2, . . . fails to meet the predefined quality criterion QC, a trigger signal is generated by the deviation detector DD and transmitted to an interrogation device IR of the monitoring device MON.

For the present exemplary embodiment, it is assumed that a deviation from the target curve SV is only detected for the operating signal curves B1 and B2 and that only the quality parameter Q1 fails to meet the quality criterion QC. As a result, a trigger signal TR1 is generated for the pair (B1, Q1) and a trigger signal TR2 is generated for the pair (B2, Q2) and fed into the interrogation device IR. The trigger signal TR1 comprises the operating signal curve B1 and the quality parameter Q1 and the trigger signal TR2 comprises the operating signal curve B2 and the quality parameter Q2.

The trigger signal TR1 prompts the interrogation device IR to check whether one or more fault causes are assigned to the operating signal curve B1 contained in the trigger signal TR1 and to the quality parameter Q1 contained in the trigger signal TR1 in the monitoring database DB. Accordingly, the trigger signal TR2 prompts the interrogation device IR to check whether one or more fault causes are assigned to the operating signal curve B2 contained in the trigger signal TR2 in the monitoring database DB.

The monitoring database DB stores and organizes acquired operating signal curves, quality parameters and, if necessary fault causes as nodes in a knowledge graph KG. In this case, one or more quality parameters acquired in this operating signal curve and, if necessary, one or more fault causes causing such an operating signal curve are assigned to a respective operating signal curve. Accordingly, one or more fault causes resulting in such a quality parameter as well as any other resulting quality parameters may be assigned to an acquired quality parameter. The above assignments are stored as edges in the knowledge graph.

As already indicated above, the operating signal curves can each be stored in the knowledge graph KG in the form of a time series, a characteristic signal pattern or a cluster recognition. Quality parameters and fault causes can each be specified by one or more numerical values and/or semantically. In this way, semantically specified quality parameters such as “Abnormal milling depth”, “Excessive vibration during milling operation” or “Inconsistent milling speed” or semantically specified fault causes such as “Worn-out milling tool”, “Incorrect milling tool alignment” or “Insufficient lubrication” can be assigned to an operating signal curve in the knowledge graph KG.

In order to check whether one or more fault causes are assigned to the operating signal curve B1 or B2 in the knowledge graph KG, the operating signal curve B1 or B2 is transmitted from the interrogation device IR to the monitoring database DB. Here it is checked whether the operating signal curve B1 or B2 or a similar operating signal curve is stored in the knowledge graph KG.

For this purpose, the similarity between the operating signal curve B1 or B2 and one or more operating signal curves stored in the knowledge graph KG is compared. Depending on how the operating signal curves to be compared are represented by time series, signal patterns or cluster recognitions, it is checked whether, for example, the Euclidean distance between representing vectors of the time series or signal patterns to be compared exceeds a predefined threshold value, or whether the curves to be compared are in different clusters.

If an operating signal curve is found in the knowledge graph KG, in which the threshold value is not exceeded, or that is in the same cluster as the operating signal curve B1 or B2, the operating signal curve B1 or B2 is considered to be contained in the knowledge graph KG. In this case, it is also checked whether one or more fault causes are assigned to the found operating signal curve (also denoted by the reference sign B1 or B2 in FIG. 2) in the knowledge graph KG. If at least one fault cause is assigned, this at least one fault cause is transmitted from the monitoring database DB to the interrogation device IR.

For the present exemplary embodiment, it is assumed that the operating signal curve B1 is stored in the knowledge graph KG, but no fault cause is assigned to it. As a result, a blank message ø is transmitted from the monitoring database DB to the interrogation device IR, the message signaling to the interrogation device IR that the operating signal curve B1 is not assigned to any fault cause.

It is also assumed that the operating signal curve B2, also stored in the knowledge graph KG, is assigned a fault cause F2. As a result, the fault cause F2 is transmitted from the monitoring database DB to the interrogation device IR.

By means of the blank message ø related to the operating signal curve B1, the interrogation device IR is prompted to output by way of a user interface IO of the interrogation device IR a request REQ for entering a fault cause to an operator USR of the production machine PM. The request REQ contains in particular a piece of information about the corresponding quality parameter Q1, for example the quality parameter Q1 itself, and a piece of information about the corresponding operating signal curve B1, for example the operating signal curve B1 itself.

In many cases, the information about the operating signal curve B1 that deviates from the target curve SV and the quality parameter Q1 that fails to meet the quality criterion QC enable the operator USR to find a cause for the deviation from the target curve SV and/or for the failure to meet the quality criterion QC. The user USR then enters the cause found as a fault cause F1 via the user interface IO.

The entered fault cause F1 is fed into the monitoring database DB by the interrogation device IR and assigned to the corresponding operating signal curve B1 and the corresponding quality parameter Q1 in the knowledge graph KG.

If necessary, multiple fault causes can also be read in by the operator USR or by multiple operators for the operating signal curve B1 and the quality parameter Q1 and assigned to the corresponding operating signal curve B1 and the corresponding quality parameter Q1 in the knowledge graph KG.

As already mentioned above, in contrast to the operating signal curve B1, the operating signal curve B2 is already assigned a fault cause F2 in the knowledge graph KG. By transmitting the fault cause F2 related to the operating signal curve B2, the interrogation device IR is prompted to output the fault cause F2 to the operator USR via the user interface IO and/or to actuate the production machine PM depending on the fault cause F2.

The output of the fault cause F2 informs the operator USR of the possible cause of the deviation between the operating signal curve B2 and the target curve SV. In many cases, this enables the operator to initiate suitable, cause-specific countermeasures at an early stage.

The operator USR can also be requested via the user interface IO to confirm or correct the fault cause F2 that is output or to enter one or more additional fault causes. A corrected or additional fault cause can then be assigned to the corresponding operating signal curve in the knowledge graph KG, as described above.

If multiple fault causes are assigned to an operating signal curve in the knowledge graph KG, these can be output in the form of a selection menu via the user interface IO. The originally assigned fault causes can then be replaced by one or more fault causes selected in this way in the knowledge graph KG.

If the production machine PM has its own diagnostic capabilities, one or more fault causes originating from the production machine PM can also be output via the user interface IO.

In addition, the interrogation device IR can be equipped with a pretrained large language model LLM, such as GPT-4, GPT-3, BLOOM, LLaMA, T5-11B, PaLM-E, Gemini Pro or Mixtral 8x7b. The large language model LLM is pretrained to use input text to generate response texts related thereto. In the present exemplary embodiment, the large language model LLM is supplied with operating signal curves, quality parameters, fault causes and their mutual assignments in text form stored in the knowledge graph KG, for example within the scope of finetuning or another form of post-training. The large language model LLM can be used to answer user requests, in particular relating to operating signal curves, quality parameters and fault causes, in natural language by means of response texts.

Thus, a user request formulated in natural language can be read in by way of the user interface IO and fed into the large language model LLM in the form of an input text. The latter then generates from this a response text in natural language, which is then output by the user interface IO. This enables the operator USR to communicate in natural language via the user interface IO. In many cases, additional useful information can be obtained from a respective response text, insofar as large language models often have good inference and abstraction capabilities, as experience has shown.

As already indicated above, the fault cause F2 can be used alternatively or additionally to actuate the production machine PM in order to automatically initiate suitable, fault-specific countermeasures. For this purpose, the fault cause F2 is transmitted from the interrogation device IR to a control device CLT of the monitoring device MON. The control device CTL is used to actuate the production machine PM. For this purpose, the control device CTL derives a suitable control signal CS from the fault cause F2 and transmits it to the production machine PM in order to actuate it accordingly.

In this way, the production machine PM can be prompted by the control device CTL in particular to output an alarm signal, to assume a safety state, to output operating instructions and/or to stop or slow down machining of at least the current workpiece in a manner specific to the fault cause.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for monitoring a production machine, wherein, during operation of the production machine,
a) a current operating signal of the production machine is continuously acquired;
b) a time window wherein the respective workpiece is machined by the production machine is acquired for each of a large number of workpieces;
c) a curve of the operating signal that is limited to the respective time window is acquired for each time window;
d) a respective quality parameter of the respective workpiece being machined is acquired;
e) as a result of detection of a deviation between a respective operating signal curve and a target curve, it is checked whether a fault cause is assigned to the respective operating signal curve in a monitoring database; and,
if this is not the case,
a piece of information about the respective quality parameter is output by way of a user interface together with a request to enter a respective fault cause;
the respective fault cause is read in by way of the user interface; and
the respective operating signal curve, the respective quality parameter and the respectively read-in fault cause are stored in the monitoring database in a manner assigned to one another and;
otherwise,
the assigned fault cause is output and/or the production machine is actuated depending on the assigned fault cause.

2. The method as claimed in claim 1, wherein the respective operating signal curve, the respective quality parameter and the respectively read-in fault cause are stored in a knowledge graph in a manner assigned to one another.

3. The method as claimed in claim 1, wherein a pattern recognition routine extracts a characteristic signal pattern from each of the acquired operating signal curves, in that, in order to detect the deviation from the target curve, the respectively extracted signal pattern is compared with a target signal pattern extracted from the target curve by the pattern recognition routine; and
in that the respective operating signal curve is stored in the monitoring database in the form of the respectively extracted signal pattern.

4. The method as claimed in claim 1, wherein the acquired operating signal curves are subjected to a cluster analysis by means of a clustering routine, wherein the acquired operating signal curves are divided into clusters of similar operating signal curves,
in that, in order to detect the deviation from the target curve, it is checked whether the respective operating signal curve is in the same cluster as the target curve; and
in that the respective operating signal curve is stored in the monitoring database in the form of an identifier of the corresponding cluster.

5. The method as claimed in claim 1, wherein, if the respective quality parameter fails to meet a predefined quality criterion, it is checked whether a fault cause is assigned to the respective quality parameter in the monitoring database and;
if this is not the case, the information about the respective quality parameter is output by way of the user interface together with the request to enter the respective fault cause.

6. The method as claimed in claim 1, wherein the target curve is derived from previous operating signal curves wherein the quality parameter in question has met a predefined quality criterion.

7. The method as claimed in claim 1, wherein the respective quality parameter is determined by means of an optical sensor, by means of a camera and/or by means of a sensor for measuring a geometric property, an electrical property, a mechanical property, an optical property or a material property or for measuring a surface roughness.

8. The method as claimed in claim 1, wherein a piece of information about the respective operating signal curve is also output by way of the user interface together with the information about the respective quality parameter.

9. The method as claimed in claim 1, wherein it is checked whether a quality parameter is assigned to the respective operating signal curve in the monitoring database and;
if this is the case, the assigned quality parameter is output and/or the production machine is actuated depending on the assigned quality parameter.

10. The method as claimed in claim 1 wherein a large language model, which is pretrained to use input text to generate response texts related thereto, is provided,
in that the stored operating signal curves, quality parameters, fault causes and their mutual assignments are supplied to the large language model in text form;
in that the user interface is used to read in a user request and feed it in the form of an input text into the large language model which generates a response text therefrom; and
in that the response text is output by way of the user interface.

11. The method as claimed in claim 1, wherein, if multiple fault causes are assigned to the respective operating signal curve in the monitoring database, these fault causes are output by way of the user interface in order to select an appropriate fault cause.

12. The method as claimed in claim 1, wherein operational signal curves and/or quality parameters of multiple production machines are acquired and stored in the monitoring database for all production machines; and
in that an operating signal curve and/or quality parameter acquired in a first production machine is assigned a fault cause in a second production machine, different from the first production machine, in the monitoring database.

13. A monitoring device for monitoring a production machine, set up for carrying out the method as claimed in claim 1.

14. A computer program product, comprising a computer readable hardware storage device having computer readable program code stored therein, the program code executable by a processor of a computer system to implement a method as claimed in claim 1.

15. A computer-readable storage medium comprising a computer program product as claimed in claim 14.
